(19) United States
(12) Patent Application Publication
(10) Pub. No.: US 2005/0094338 A1
(43) Pub. Date: May 5, 2005

(54) Recloser control apparatus compatible with various reclosers for protection of power systems

(76) Inventors: Timothy Minteer, Pullman, WA (US); Eric Horn, Pullman, WA (US)

Correspondence Address: Jensen & Puntigam, P.S., Suite 1020, 2033 Sixth Avenue, Seattle, WA, 98121, US

(21) Appl. No.: 10/697,904

(22) Filed: Oct. 29, 2003

(51) Int. Cl. H02H 3/00

(52) U.S. Cl. 361/71

(57) ABSTRACT

The recloser control apparatus is compatible with reclosers from various recloser manufacturers. The recloser control apparatus includes a protective relay for power lines which is responsive to voltage and current values from the power line to identify faults on the line, and operates in combination with a recloser apparatus to restore power to areas of the power system which are unaffected by a fault but which have initially been put out-of-service in response to the fault. The apparatus includes a control interface capable of being selectively modified to provide control signals for a plurality of different reclosers having different control signal requirements for operation of their trip and close control circuits.

### TECHNICAL FIELD

This invention generally concerns recloser control apparatus, and more specifically concerns recloser control apparatus adapted to be used with different reclosers from various manufacturers.

### BACKGROUND OF THE INVENTION

A recloser is a device used in electric power systems to reclose a circuit breaker after it has been tripped (opened) as a result of a determination of a fault condition on the power line and subsequent action by a protective relay. If the fault condition is temporary, for instance, the recloser is used to restore service quickly to the entire portion of the power system affected, after the fault has disappeared. Further, reclosers can be used to restore service to part(s) of the power system actually unaffected by a fault condition following isolation of the fault to a smaller portion of the system than originally affected. Hence, reclosers and the reclosing process is an important part of a reliable power system.

Typically, a recloser manufacturer, of which there are many, will make both the recloser apparatus, also known as a fault-interrupting switch, and the control apparatus for the recloser, which typically has the capability of a protective relay relative to the identification of power system faults, but which provides output signals which are not only appropriate for tripping, i.e. opening, a circuit breaker, but also operating a recloser associated therewith.

Typically, there will be an interface connection between the recloser and the recloser control apparatus. However, such an interface is not standardized and is typically considered proprietary by the recloser manufacturer. Any party desiring to make a recloser control apparatus must conform to the interface requirements of the recloser to which it will be connected and which it will control. Each recloser control apparatus, whether provided by the recloser manufacturer or by another party, will be useful with only one recloser. Each recloser requires a different set of, and arrangement of, output signals from the control apparatus and a different interface. In some cases, the recloser manufacturer will supply electronic conversion interfaces to accommodate a particular recloser control to their recloser. However, this is not typical, and again is based on the approach of a recloser control apparatus being particularly adapted for an existing recloser.

Accordingly, it would be desirable to have a recloser control apparatus which is adapted to be able to provide appropriate control signals to various reclosers.

### SUMMARY OF THE INVENTION

Accordingly, the present invention is a recloser control apparatus compatible with various reclosers which have different voltage requirements for their trip and close circuits, comprising: a protective relay for power lines responsive to voltage and current values from the power line to identify faults on the power line and in combination with a recloser apparatus to restore power to selected areas of the power system which have been initially put out of service in response to a fault indication but which can safely operate; and a control interface system capable of providing control signals for a plurality of different reclosers having different control requirements, the interface system including a charging system capable of producing control voltages for controlling trip and close coils of various reclosers having different control voltage requirements.

### BRIEF DESCRIPTION OF THE DRAWINGS

FIG. 1 is a generalized block diagram showing a reclosing relay, a power module associated with the relay and a representative variable output for control of a recloser attached thereto.

FIG. 2 is a block diagram showing in more detail the power module portion of the system of FIG. 1.

FIG. 3 is a block diagram of one portion of FIG. 2.

FIG. 4 is a diagram showing the housing of the apparatus of FIG. 1.

### BEST MODE FOR CARRYING OUT THE INVENTION

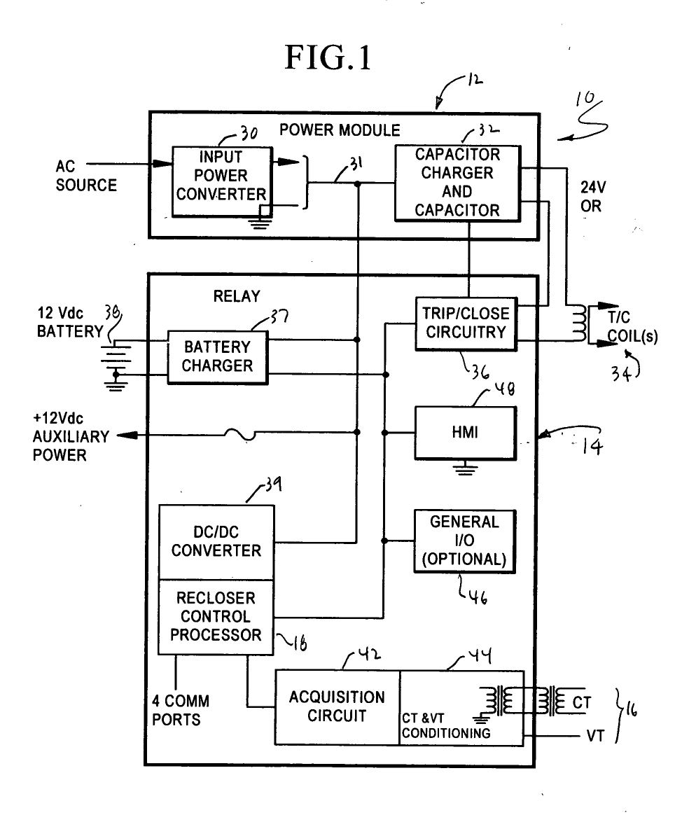

FIG. 1 shows a basic block diagram of the recloser control apparatus of the present invention, referred to generally at 10. In general, recloser control apparatus is well known. Recloser control apparatus 10 includes a power module portion 12 and a protective relay portion 14. The protective relay portion 14, responsive to voltages and currents from the power line through voltage transformers (VTs) and current transformers (CTs), shown generally at 16, processes those values by a microprocessor, shown generally at 18, to produce trip signals which are applied to a circuit breaker for the power line when faults are determined. The power module 12 provides the voltage signals required to operate the trip and close coils of a particular recloser. The recloser may have different trip and close coil arrangements and different voltage requirements, depending on the manufacturer.

Referring to FIG. 1 now in more detail, relative to the power module, an input power converter 30 converts a 120/230 volt AC source input to a 12 volt DC regulated bus voltage on bus line 31 which is referenced to system ground. The AC source voltage is provided externally from a power transformer (not shown), typically connected to the power line on the source side of the recloser. Alternatively, the power transformer could be connected to the other side of the recloser.

The 12 volt DC bus signal is applied to a capacitor charger and capacitor circuit 32 which is an important aspect of the circuit of the present invention, since it supplies the different voltages for use with the plurality of different trip and close coil arrangements of the various reclosers to be served by the recloser control apparatus 10. Circuit 32 supplies the energy to operate the trip and close coils, shown generally at 34, of the recloser, through trip/close circuit 36. The trip and close coils 34 can take various arrangements, as explained in more detail below. The voltage signals from circuit 32 can either be used directly or indirectly by “dumping” energy into capacitors, which in turn dumps into the coils. The capacitor(s) will then recharge at a relatively slow rate, but fast enough to supply energy for subsequent reclosing and tripping cycles.

A battery charger 37 maintains the charge on the 12 volt DC battery 38, which is referenced to system ground, by controlling the output voltage therefrom. In the event that no power is being delivered by the input power converter 30 to the 12 VDC bus, battery charger 37 drives the 12 volt DC bus 31 with the 12 volt DC battery source.

Referring to FIG. 1, the 12 volt battery also acts as an auxiliary power source, capable of supplying power to auxiliary electronic devices provided by an OEM or other utility customers. A DC-DC converter 39 provides +5 volts DC and ±15 volts DC signals from the 12 V bus line for powering the relay portion 14.

Acquisition circuit 42 has 12 analog channels and is capable of producing 32 samples per power system cycle of the input signals from a CT and VT conditioning circuit 44, which is responsive to the signals from the CTs and VTs 16. I/O circuit 46 provides an input/output capability for the control apparatus, while the HMI (human machine interface) circuit 48 provides for operator communication with the relay portion 14.

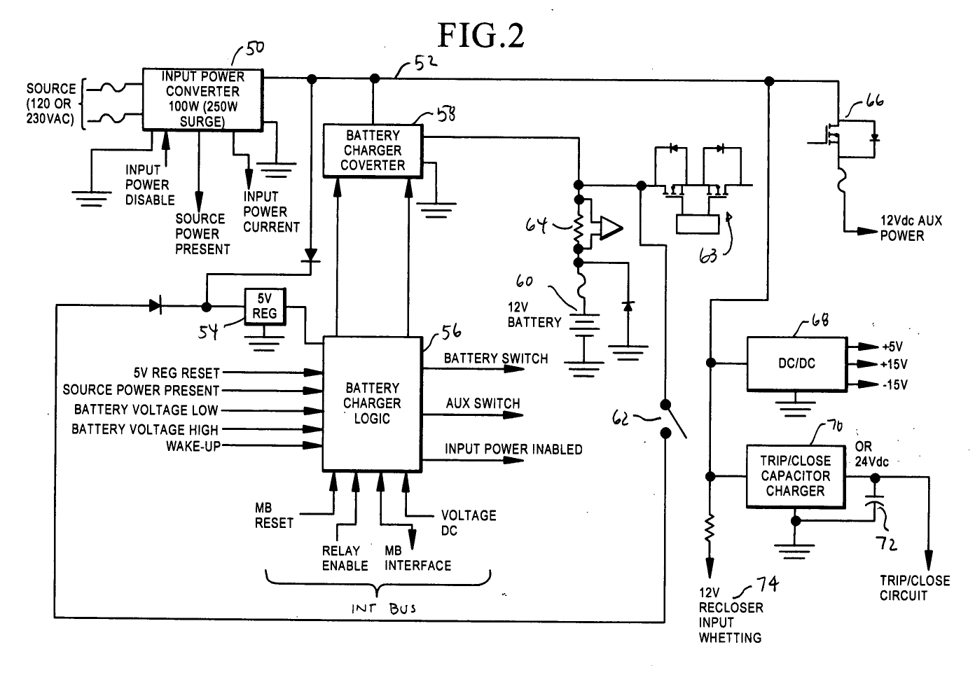

FIG. 2 shows a functional block diagram relative to the power portion of the control apparatus. The independent power converter is shown at 50, responsive to a 120 or 230 volt AC source input. The output of the power converter 30 is applied to a 12 volt DC bus, referred to at 52. The 12 volt DC signal is compatible with a variety of reclosers. The 12 volt bus 52 feeds a 5 volt regulator circuit 54, which provides power to a battery charger logic circuit 56. The battery charger logic circuit controls a battery charger converter 58, which is also connected to the 12 volt bus 52. The battery charger logic circuit 56 has a number of inputs as well as outputs, some provided by an internal bus. The 5 volt regulator circuit 54 can also be powered by the 12 volt battery 60 by operating a push-button switch 62.

The battery charger converter 58, a SEPIC (single end primary inductor circuit) converter, is a DC/DC converter which is programmed to charge the 12 volt battery 60 through a current sensing resistor 64.

The 12 volt bus 52 also is connected to an auxiliary switch 66 which, when closed, can power an external electrical load, i.e. serve as a 12 volt auxiliary DC power source. The external load can draw current from the input power converter 50, or from the 12 volt battery 60 if the battery switch 63 is closed.

The 12 volt bus 52 also connects to another DC/DC converter 68 which provides several output voltages (+5 volts and ±15 volts) to power the various electronic circuits in the control apparatus.

Further, the 12 volt bus 52 powers another DC/DC converter 70 which provides the specific output voltages which are compatible with the recloser coil voltage requirements. The output voltages from this circuit can be changed or added to accommodate the voltage requirements of various reclosers. Outputs of 24 volts and 53 volts are shown, but it should be understood that other voltages may be produced, to meet the requirements of particular reclosers, such as 100 volts, 125 volts or greater. Hence, the recloser control apparatus of the present invention is adapted for use with a plurality of reclosers, not just one, and does not have to have a particular interface for each recloser. As shown, circuit 70 can provide voltage signals directly to the recloser circuits, or it can store energy on a charge storage capacitor 72, which in operation will dump its stored energy into the recloser control (trip/close) circuits.

The 12 volt bus also powers various indication contacts in the recloser, referred to as whetting inputs 74.

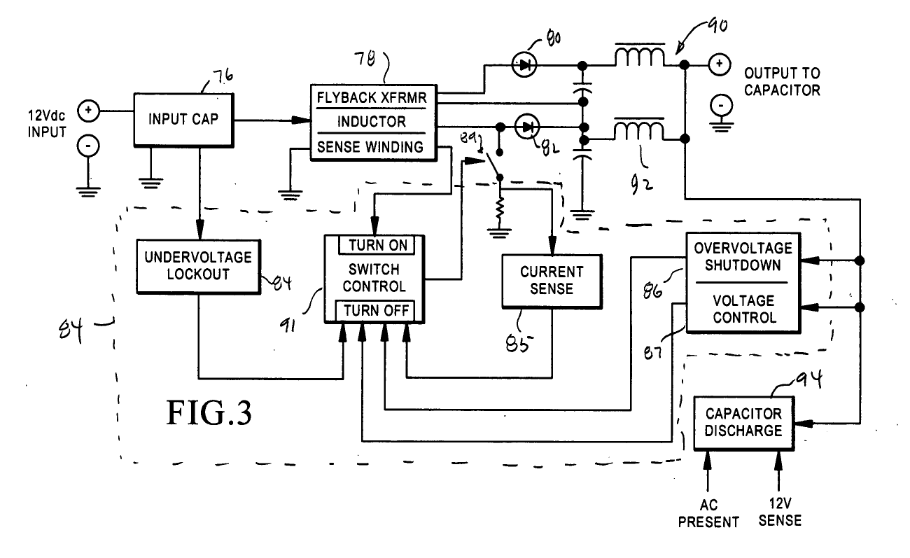

FIG. 3 shows in more detail the trip/close capacitor charger circuit 70 of FIG. 2. Referring to FIG. 3, the circuit includes an input capacitor 76, responsive to a 12 VDC input from the input bus 52, although voltages within a range of 8-16 volts can also be used. Flyback transformer 78 includes a primary winding section, a secondary winding section (inductor) and a sense winding. Depending upon the particular recloser, two or three of the windings are used. The switching element includes an FET 89 and two catch diodes 80 and 82. FET 89 is controlled by a control system 84 which includes a switch control element 91 and which determines when to turn on and turn off the FET 89. A number of circuit conditions can turn off the FET, but there is only one condition that turns on the FET. Any turn-off condition overrides the turn-on condition. In the embodiment shown, the turn-on condition is zero current in the flyback transformer 78. The turn-off conditions include peak current detected in the flyback transformer 78 by circuit 85, under-voltage lockout 84, shutoff voltage reached 87 and over-voltage shutoff 86.

The circuit also includes output filtering using inductors 90 or 92, depending upon which voltage output is to be used. The output is adapted to the output circuit capacitors.

A capacitor discharge circuit 94 in operation drains energy from the output capacitors, ensuring that the voltage is at a safe level when the system is not being used. The circuit is intended to bring the voltage on the capacitors below 40 volts within one minute when it has been determined that the circuit is not in use. Again, the capacitor discharge circuit will vary in the value of its components, depending upon the voltage being supplied to the recloser.

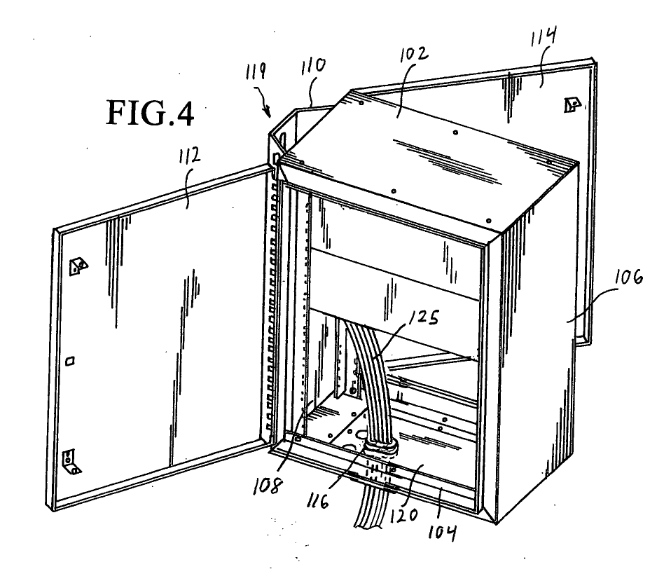

FIG. 4 shows an enclosure 119 for the recloser control of the present invention. The enclosure 119 includes top and bottom sections 102, 104 and side portions 106, 108. Along one side is a pole bracket 110 for connection to a utility pole. The enclosure includes front and rear doors 112 and 114, both of which can be opened separately (and are separately lockable) for access to the front and rear of the recloser control apparatus. The front includes display panels and interface controls, while the rear includes wire contacts.

Besides being capable of providing different voltages necessary for the trip and close coils for various reclosers, another significant difference of the apparatus of the present invention, relative to conventional recloser controls, is the wire connector/interface between the recloser control apparatus and the recloser. For instance, one particular recloser requires a 14-pin connector/interface for required signals from the recloser control apparatus, while in another case, 40, 50 or even 70-pin connectors are used. The connector interface 116 is mounted in a removable panel 120 at the bottom of the enclosure 119. Instead of just drilling a hole in the bottom section 104, the removable panel 120 with the correct size opening to accommodate a particular recloser connector is fitted into place against the bottom section 104.

Typically, panel 120 will be mounted from inside the enclosure 119, to prevent theft/vandalism. A seal such as a gasket can be placed if desired between panel 120 and the bottom section 104, to seal the panel/bottom section against water or dust entering the enclosure. In the embodiment shown, the bottom section has threaded studs which extend upwardly from the interior surface of the bottom section, through openings in the panel. Nuts are then used to tighten the panel against the bottom section. The panel thus can not be removed from outside the enclosure.

Each recloser will have a certain pattern of, and number of, input wires connected to its circuitry. The recloser control apparatus must have a set of wires from its control circuits which mirror the wire pattern for the recloser. The two groups of wires join at the two part wire connector. In the present invention, a wiring bundle 125 is compiled from the recloser control to match the wiring bundle 127 from the recloser which it is to control. The wires from the recloser control apparatus are connected to the appropriate contact switches providing the correct output signals for the recloser to which it is to be connected.

Accordingly, a recloser control apparatus has been disclosed which is designed to be operable with a variety of individual recloser devices from various manufacturers.

Although a preferred embodiment of the invention has been disclosed here for purposes of illustration, it should be understood that various changes, modifications and substitutions may be incorporated without departing from the spirit of the invention, which is defined by the claims which follow.

1. A recloser control apparatus compatible with various reclosers, comprising:
a protective relay for power lines responsive to voltage and current values from the power line to identify faults present on the power line and in combination with a recloser apparatus to restore power to selected areas of the power system which have been initially put out of service in response to a fault indication; and
a control interface system capable of providing control signals for a plurality of different reclosers having different control requirements, the interface system including a charging system capable of producing control voltages for controlling trip and close coils of various reclosers having different control voltage requirements.

2. The apparatus of claim 1, including an input power converter for providing the control interface, including the. charging system with a 12 volt bus signal, the power converter being responsive to a source voltage to produce the 12 volt signal.

3. The apparatus of claim 1, including a DC/DC converter for producing the voltages necessary to power the recloser control apparatus from the 12 volt DC bus line.

4. The apparatus of claim 1, wherein the charging system includes an input capacitor, a flyback transmitter, a switching element with a control circuit, an output filter and a capacitor discharge circuit for producing the selected voltages for the trip and close coils of the recloser.

5. The apparatus of claim 1, including a 12 volt battery, a battery charge control logic circuit and a battery charger circuit for maintaining the battery in a charged condition.

6. The apparatus of claim 1, including a housing which includes a removable plate in one portion thereof, wherein the removable plate includes an opening which is correctly sized for a wiring connector between the recloser control apparatus and the recloser.

7. The apparatus of claim 1, including a housing for the apparatus having front and rear doors for access to the front and rear of the apparatus, each of said doors being separately and independently lockable.
